(19) United States
(12) Patent Application Publication
(10) Pub. No.: US 2017/0345426 A1
(43) Pub. Date: Nov. 30, 2017

(54) SYSTEM AND METHODS FOR ROBUST VOICE-BASED HUMAN-IOT COMMUNICATION

(71) Applicants: Julia Komissarchik, Draper, UT (US); Edward Komissarchik, Draper, UT (US)

(72) Inventors: Julia Komissarchik, Draper, UT (US); Edward Komissarchik, Draper, UT (US)

(21) Appl. No.: 15/607,568

(22) Filed: May 29, 2017

Related U.S. Application Data
(60) Provisional application No. 62/343,774, filed on May 31, 2016.

(51) Int. Cl. G10L 15/22; G10L 15/19; G10L 15/187; G10L 15/01; G10L 15/30; G10L 15/07

(52) U.S. Cl. CPC G10L 15/22; G10L 15/30; G10L 15/07; G10L 15/187; G10L 15/01; G10L 15/19; G10L 2015/221; G10L 2015/223; G10L 2015/227

(57) ABSTRACT

A system and method for robust voiced-based communication of humans and Internet of Things.

### FIELD OF THE INVENTION

The present invention relates generally to the field of voice-based human-machine interaction and particularly to a system of robust voiced-based communication of humans and Internet of Things devices.

### BACKGROUND OF THE INVENTION

Voice-based communication with an electronic device (computer, smartphone, car, home appliance) is becoming ubiquitous. Improvement in speech recognition is a major driver of this process. Over the last 10 years voice-based dialog with a machine changed from being a curiosity and most often a nuisance to a real tool. Personal assistants like Siri are now part of many people's daily routine. However, the interaction is still quite a frustrating experience for many. There are several reasons for that—insufficient quality of speech recognition engines, unconstrained nature of interactions (large vocabulary), ungrammatical utterances, regional accents, communication in non-native language. Over last 30 years a number of techniques was introduced to compensate for insufficient quality of speech recognition by using on the one hand more restrained dialog/multiple choice model/smaller vocabulary/known discourse, and on the other hand adaptation of a speech engine to a particular speaker. The problem with the first group of remedies is that it is not always possible to reduce real life human machine interaction to obey these restrictions. The problem with the second approach (speaker adaptation) is that to provide meaningful improvement the speech engine requires a large number of sample utterance of a user, which means that a user should tolerate insufficient quality of recognition for a while. However, even if this adaptation is accomplished, it still does not address the problem of a conversational nature of the interaction that includes hesitation, repetition, parasitic words, ungrammatical sentences etc. Even such natural reaction as speaking deliberately with pauses between words when talking to somebody who does not understand what was said, throws speech recognition engine completely off. In spite of a lot of efforts made and continued to be made by companies developing speech recognition engines such as Google, Nuance, Apple, Microsoft, Amazon, Samsung and others to improve quality of speech recognition and efficiency of speaker adaptation, the problem is far from being solved.

The drawback of forcing speech recognition engine to try to recognize human speech even if a user has serious issues with correct pronunciation and even speech impediments is that it forces the machine to recognize something that is simply not there. This leads to either incorrect recognition of what user wanted to say (but did not) or inability to recognize an utterance at all. The problem is acerbated even further for people with strong foreign accent.

Voice-based dialogs are typically designed using word and phrase nomenclature as if voice-based dialogs are the same thing as communications using text-based interface. The lack of taking into account the complexity of transforming human speech into text creates a significant impediment to a successful human-machine voice based communication.

Internet of Things (IoT) constitutes a special case for voice-based communication. IoT normally contains devices that can execute commands. Therefore, voice dialogs with most of the devices use small vocabulary and in most cases even a finite number of sentences. However, the consequences of misrecognition of a command can be quite severe. Therefore, the error rate has to be much lower than for large vocabulary voice-based applications such as dictation. For example, if voice is used to control moving objects, the error rate should be almost 0%. That level of quality is not feasible to achieve with conventional ASR's even with the most elaborate conventional speaker adaptation.

In view of the shortcomings of the prior art, it would be desirable to develop a new approach that can detect what is wrong with user pronunciation and to help user improve pronunciation and to offer user alternative phrases that have similar meaning but are less challenging to pronounce for this particular user.

It further would be desirable to provide a system and methods that can analyze existing voice based dialog nomenclature and advise designers of the system how to change nomenclature, so it conveys same or similar meaning but is easier to pronounce by different groups of users and is less confusing to ASR.

It still further would be desirable to provide a system and methods that can analyze the existing voice based dialog nomenclature and pronunciation peculiarities and errors of a user and provide a user with alternative phrases with the same meaning that are less difficult for user to pronounce correctly and that are less confusing to ASR.

It still further would be desirable to provide a system and methods of using an intermediary system that can take utterances from a user with strong foreign accent in his or her native tongue and produce voice output in the language that IoT device or IoT control box can reliably recognize.

### SUMMARY OF THE INVENTION

The present invention is a system and method for building a robust system for voice-based communication between humans and IoT devices based on analyzing the phrase structures, recognition errors, and by applying error avoidance techniques and intermediary devices to improve quality of recognition and usability of communication.

In view of the aforementioned drawbacks of previously known systems and methods, the present invention provides a system and methods for detecting what is wrong with user pronunciation and helping the user to modify his or her pronunciation to achieve better recognition results. Furthermore, it provides for an intermediary system that converts user speech in one language to another to enable users with strong foreign accent to communicate with IoT successfully.

This patent looks at the task not as a problem of recognizing user utterances, but as a command-and-control channel between user and device with user utterance at one end and one of the commands that device can obey at another. In some cases (e.g. for some users or for some command structures) this channel can have just an ASR. In other cases it can require additional devices, use of non-speech related mechanisms (e.g. encoding or phrase alterations) or use of speech but in a different language (e.g. use of first language for non-native speakers, or use of language that ASR's recognize better, such as English).

The approach of this invention is to analyze the results of speech recognition of one or many utterances and provide feedback to a user on how to improve recognition by changing user speech. This includes among others things focus on correcting mispronunciation of certain phonemes, triphones and words and making changes in utterance flow.

The present invention further provides alternative phrases to ones that user cannot pronounce correctly that have same or similar meaning but are less challenging to pronounce for this particular user and that are recognized better by a machine.

In accordance with one aspect of the invention, a system and methods for improving speech recognition results are provided wherein the response of a publicly accessible third party ASR system to user utterances is monitored to detect mispronunciations and pronunciation peculiarities of a user.

In accordance with another aspect of the invention the system and methods for automatic feedback are provided to assist users to correct mispronunciation errors and to suggest alternative phrases with the same or similar meaning that are less difficult for user to pronounce correctly that lead to better recognition results.

In accordance with another aspect of the invention the system and methods are provided for automatic conversion of user utterances spoken in one language to voice output in another language that is supplied to voice-enabled electronic device that help users with strong foreign accent to communicate with electronic devices.

This invention can be used in multiple situations where a user talks to an electronic device. It is especially useful in the areas such as Internet of Things and Auto where the combination of relatively limited vocabulary and a necessity of very high quality of speech recognition are typical.

Though some examples in the Detailed Description of the Preferred Embodiments Invention and in the Drawings are referring to English language, the one skilled in the art will see that the methods of this invention are language independent and can be applied to any language and can be used in any voice-based human-machine interaction based on any speech recognition engine.

### BRIEF DESCRIPTION OF THE DRAWINGS

Further features of the invention, its nature and various advantages will be apparent from the accompanying drawings and the following detailed description of the preferred embodiments, in which:

FIGS. 1 and 2 are, respectively, a schematic diagram of the system of the present invention comprising software modules programmed to operate on a computer system of conventional design having Internet access, and representative components of exemplary hardware for implementing the system of FIG. 1.

FIG. 3 is a schematic diagram of aspects of an exemplary speech analysis system suitable for use in the systems and methods of the present invention.

FIG. 4 is a schematic diagram depicting an exemplary embodiment of a user feedback system in accordance with the present invention.

FIG. 5 is a schematic diagram depicting an exemplary embodiment of a speech conversion system in accordance with the present invention.

FIGS. 6a-6d are schematic diagrams depicting exemplary embodiment of system configurations in accordance with the present invention.

### DETAILED DESCRIPTION OF THE PREFERRED EMBODIMENTS

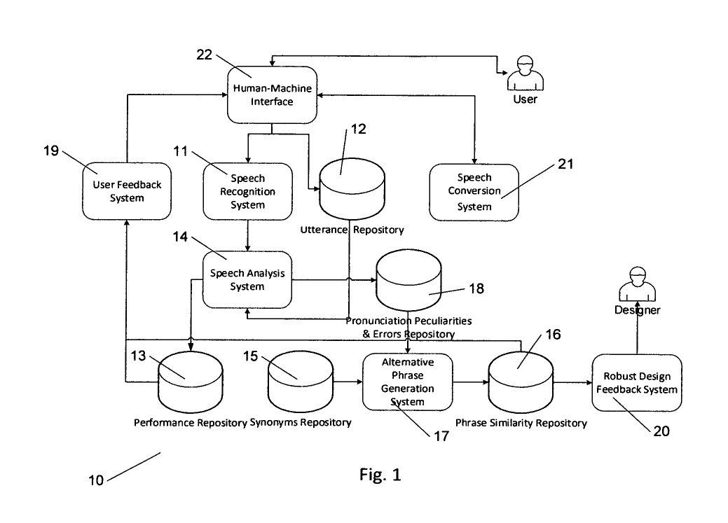

Referring to FIG. 1, system 10 for robust voice-based human-IoT communication is described. System 10 comprises of a number of software modules that cooperate to detect mispronunciations in a user's utterances, to detect systematic speech recognition errors caused by such mispronunciations or ASR deficiencies, provide detailed feedback to the user that enables him or her to achieve better speech recognition results. Furthermore, it comprises of modules that build and modify voice-based dialogs by anticipating what can be problematic in talking to a machine for all users, for some categories of users, or for an individual user.

In particular, system 10 comprises of automatic speech recognition system (“ASR”) 11, utterance repository 12, performance repository 13, speech analysis system 14, synonyms repository 15, phrase similarity repository 16, alternative phrase generation system 17, pronunciation peculiarities & errors repository 18, user feedback system 19, robust design feedback system 20, speech conversion system 21, and human-machine interface component 22.

For some of these systems ways to build them were introduced in patent application Ser. No. 15/587,234 and patent application Ser. No. 15/592,946 (which are incorporated here by reference). However, the context of IoT though providing some advantages like small to medium vocabulary creates additional challenges due to the requirement of higher level of robustness.

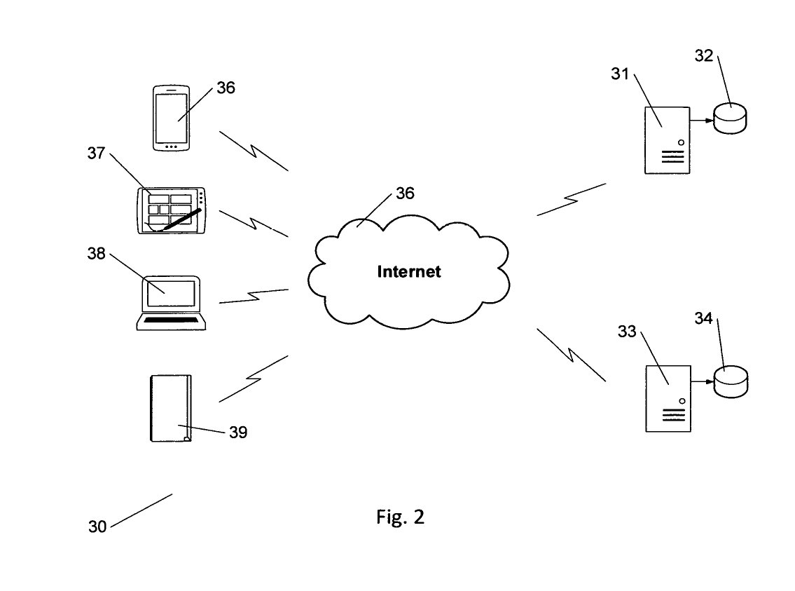

Components 11-22 may be implemented as a standalone system capable of running on a single personal computer. More preferably, however, components 11-22 are distributed over a network, so that certain components, such as repositories 12, 13, 15, 16, 18 and ASR 11 reside on servers accessible via the Internet. FIG. 2 provides one such exemplary embodiment of system 20, wherein repositories 12, 13, 15, 16, 18 may be hosted by the provider of the human-IoT voice-enable communication software on server cluster 31 including database 32, while ASR system 11, such as the Google Voice system, is hosted on server 33 including database 34. Servers 31 and 33 are coupled to Internet 35 via known communication pathways, including wired and wireless networks.

A user using the inventive system and methods of the present invention may access Internet 35 via mobile phone 36, via tablet 37, via personal computer 38, or via voice-enabled IoT control box 39. Human-machine interface component 22 and speech conversion system 21 preferably are loaded onto and run on mobile devices 36 or 37 or computer 38 or voice-enabled IoT control box 39, while utterance repository 12, performance repository 13, synonyms repository 15, phrase similarity repository 16, alternative phrase generation system 17, pronunciation peculiarities and errors repository 18, user feedback system 19 may operate either on the client side (e.g., mobile devices 36 or 37 or computer 38) or server side (e.g., server 31), while speech recognition system 11 and robust design feedback system most likely are loaded and run on a server side (e.g., server 33) depending upon the complexity and processing capability required for specific embodiments of the inventive system.

Each of the foregoing subsystems and components 11-22 are described below.

Automatic Speech Recognition System (ASR)

The system can use any ASR. In voice-enabled communication with IoT a user can encounter different ASRs. A number of companies (e.g. Amazon, Google, Apple, and Microsoft) build speech interaction mechanisms to communicate with different IoT devices. Depending on configuration (see FIG. 1), communication with IoT can be done through a standalone device like Amazon Echo or through a voice-enabled application on a smartphone, or directly with an IoT device. For example, some of the interactions can be done through Amazon Echo device while others can be done through Microsoft Cortana, and some can be done with a speech-enabled application on a smartphone that either serves as an intermediary device to the likes of Amazon Echo or can directly provide commands to IoT devices. Furthermore, it can be with a speech recognition system installed on the IoT device itself.

Utterance Repository

To be able to provide a more balanced feedback to a user regarding user's speech intelligibility to a machine, a repository of user's utterances and ASR results is maintained. For each utterance stored in the repository, the following information can be stored:
Text that the user was supposed to utter
The recording of the utterance
Acoustic features of the utterance
For each recognition, alternative parameters such as confidence level, position in the N-Best list

For non-native speakers the repository can also contain parallel texts of utterances in native and foreign languages (e.g. Korean-English).

Performance Repository

Performance Repository contains historical and aggregated information of user pronunciation. Its purpose is to provide user with a perspective of user's voice-based interaction with a machine and to store information about main aspects of user pronunciation to be modified to increase user's intelligibility to machine. The Performance Repository can contain the following information:
History/Time Series of recognition of individual phonemes, words and collocations
Comparative recognition results for difficult (for user) words/phrases to pronounce and their easier to pronounce synonyms
History/Time Series of speech disfluencies

Though the repository's main purpose is to help individual user improve voice-based communication with machine, a combined repository for multiple users can be used by designers of human-machine interface to improve the interface. For example, in case of voice-based dialog/command systems it might lead to changes in the vocabulary used in such a system.

For the configuration when an intermediary device (e.g. smartphone) is used to mitigate voice-based communication with IoT for non-native speakers and speakers with heavy regional accents and speech impediments this repository can store not only the results of ASR used on this device, but (when available) the success rate in communication with the Amazon Echo like systems that send commands to the IoT devices.

Speech Analysis System

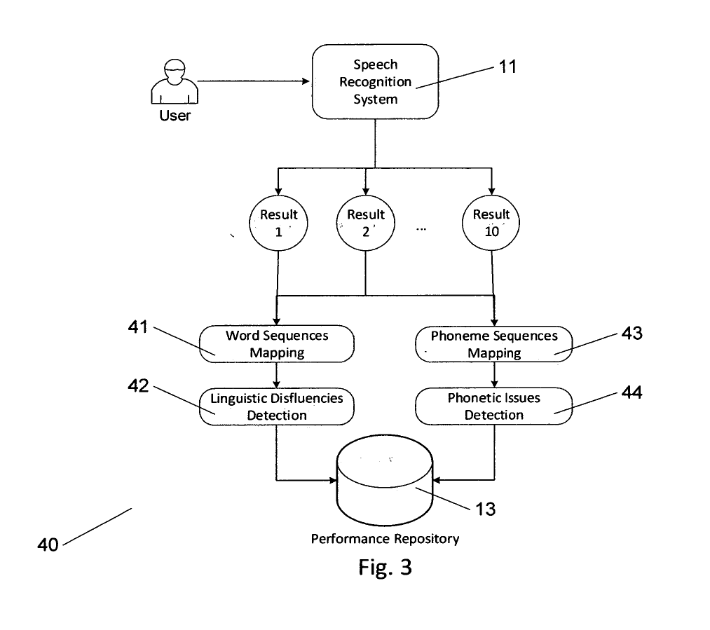

Referring now to FIG. 3, the speech analysis system 40 analyses ASR results both in cases when it is unknown what phrase was pronounced or supposed to be pronounced by a user (Unsupervised Analysis) and in cases when a user is supposed to pronounce a phrase from a predefined list (Supervised Analysis). The unsupervised situation is atypical for voice-based communication with IoT. However, this analysis can be useful in initial stages of interaction of an individual user with IoT especially in cases of speech impediments or when a user is a non-native speaker. For detailed description of both unsupervised and supervised speech analysis, see the aforementioned two patents.

The Speech Analysis System consists of the following subsystems:
Word Sequences Mapping 34
Linguistic Disfluency and Grammar Issues Detection 35
Phoneme Sequences Mapping 36
Phonetic Issues Detection 37

For non-native speakers, if the configuration is such that a user pronounces commands in user's native tongue, which are then converted into utterances played in the second language (e.g. Chinese=>English), the system is used for the analysis of utterances done in user's native tongue.

Synonyms Repository

Synonyms repository 15 can contain information about synonyms for words/collocation in a language (or several languages) of communication. The repository can be represented as a graph. Nodes are words/collocations, while edges between nodes are marked with types of the meaning or role. Furthermore, canonical (e.g. IPA-based) phonetic transcription of each node is stored.

The repository also can store information about correspondence between phrases in different languages.

Phrase Similarity Repository

While synonyms repository 15 contains synonyms for “official” words and collocations, phrase similarity repository 16 contains phrases and their “unofficial” synonyms for phrases that are important or interesting for a particular field or application. The level of similarity can also go beyond synonymy, so any two phrases can be declared synonyms, if either one can be used to communicate certain meaning in the dialog between user and electronic device. This is especially convenient for users that cannot pronounce certain things satisfactorily enough to be understood by ASR. For example, “Jonathan” can be stored as a synonym of “Jon” for the purpose of a smartphone call list. If a user cannot get satisfactory results from ASR while pronouncing the word “Jon”, the system can advise user to say the word “Jonathan” instead. Alternatively, instead of saying the word “sleet” (and getting the top ASR results like ““slit” or “sit” or “seat”) the system can advise user to use a phrase “wet snow” or “melted snow”.

In the case of IoT, commands that a particular device obeys are quite formal—they typically are represented as one or more (name, value) pairs. To make these commands accessible by voice, a device (e.g. Amazon Echo) is used to convert human intention as uttered in a natural language to these commands. Since the list of commands is finite (and in many cases is quite short) user can be allowed a significant leeway in saying what he wants the device to do in his native tongue. Therefore, the repository can contain not just a formal translation from the commands that the box like Amazon Echo will understand and interpret properly but can have large deviations from that. The latter is important to avoid phrases that either user cannot say due to his speech impediments or because ASR in his native tongue cannot reliably recognize these phrases. Therefore, the repository in this case will resemble more a codebook than a dictionary.

Alternative Phrase Generation System

Alternative phrase generation system 17 takes phrases that are relevant to a particular application and finds phrases that are similar to them in meaning but are easier to recognize by ASR. If a phrase belongs to a thesaurus, then its synonyms that belong to the thesaurus can be a starting point. However, in many cases thesaurus rules of synonymy are too strict for practical applications, where one phrase can be substituted with an alternative phrase that is not exactly synonymous but close enough to lead to the same result in communication with machine. The alternative generation algorithm deals with this situation. For detailed description of this system, see patent application Ser. No. 15/587,234.

Pronunciation Peculiarities & Errors Repository

Pronunciation peculiarities & errors repository 18 for each language contains pairs of phoneme sequences (P1, P2), where P1 is “what was supposed to be pronounced”, while P2 is “what was actually pronounced”. Each pair can have additional information about users that pronounce P2 instead of P1 with some statistical information. If P2=Ø then it means that P1 was not recognized by ASR at all. This repository can be built using general phonetics (e.g. minimal pairs), as well as history of people using a particular voice-based user interface.

For ASRs that have higher recognition rate, consistent misrecognition usually means mispronunciation, so user feedback can have more focus on improving user's speech. If the ASR does not demonstrate high level of recognition rate then it is more prudent to change the phrases to more distinct ones. Therefore, for cases of ASR's consistent misrecognition it is more beneficial to use alternative phrase generation system 17 and phrase similarity repository 16.

User Feedback System

User feedback system 19 uses information stored in utterance repository 12 and performance repository 13 to provide user with feedback on the ways to improve voice-based communication with machine.

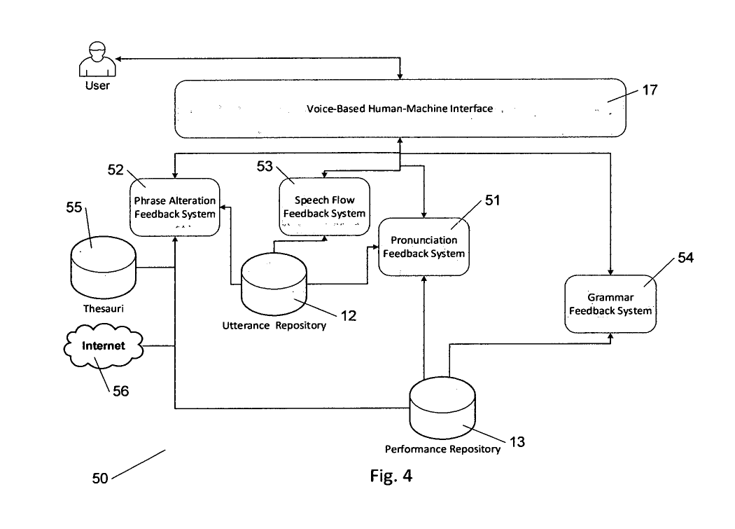

Referring now to FIG. 4, user feedback system 19 consists of the following subsystems:
Pronunciation Feedback System 51
Phrase Alteration Feedback System 52
Speech Flow Feedback System 53
Grammar Feedback System 54

For detailed description of this system, see patent application Ser. No. 15/592,946.

For communication with IoT, due to relatively short duration of commands and their, usually simple, grammar, pronunciation feedback system and phrase alteration feedback system play most important role. Moreover, due to the relatively small number of accepted commands/phrases phrase alteration can go much wider without losing command identifiable features.

Robust Design Feedback System

To make voice-based dialog more robust the words/phrases used in it should be chosen to be less prone to user mispronunciation and ASR confusion. Major factor in such a confusion is phonetic proximity between different words/phrases. If two words are pronounced similarly, ASR can recognize one word as another. However, if a word/phrase is quite distant from other words/phrases from phonetic standpoint, then confusion due to mispronunciation or ASR errors is less likely. That is the premise of the method of building robust voice-based dialogs.

For detail description of this system, see patent application Ser. No. 15/592,946.

Speech Conversion System

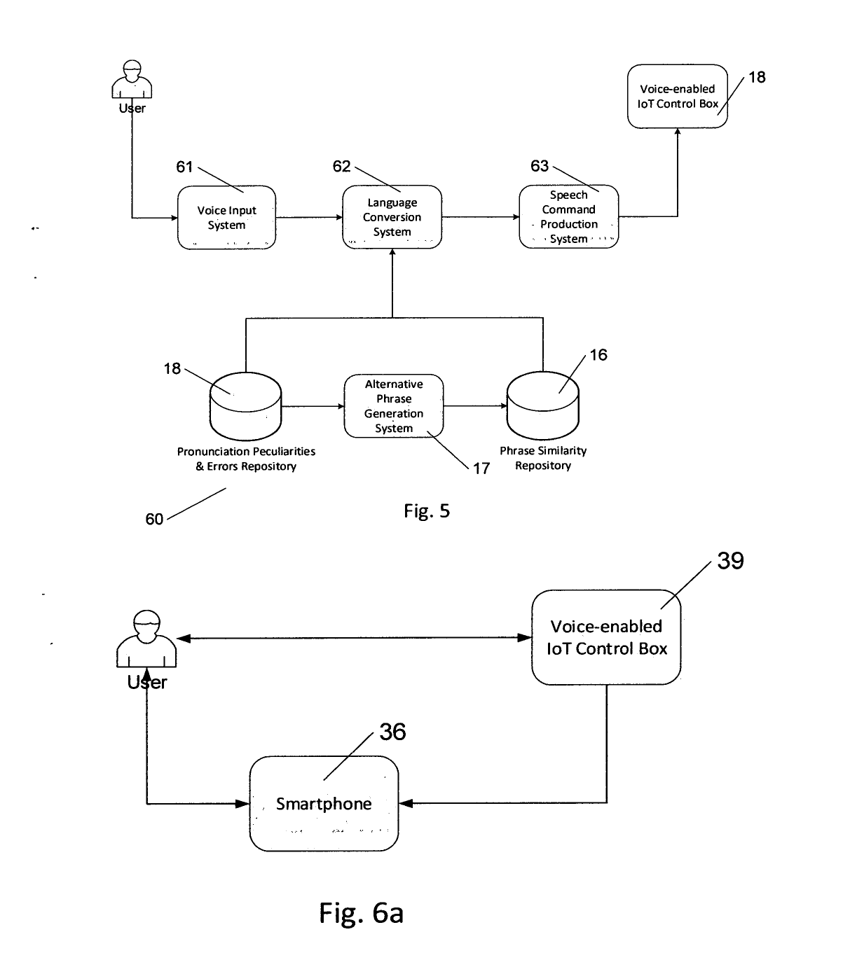

Referring now to FIG. 5 speech conversion system 21 is focused on the cases when a serious mitigation is required to make voice-communication with IoT work. These cases include users with speech impediments, strong local dialects and the cases when user is a non-native speaker and has too many issues while speaking the language that ASR can recognize well.

Speech conversion system 21 takes input from a user and produces voice output into a device like Amazon Echo that controls IoT devices. The input can be a voice command, a gesture or just a typed command on the computer or phone. A number of companies provide mechanisms for gesture recognition that can be used for this system. For typed commands, there is less an issue of misinterpreting user's intention, so for the input part of speech conversion system we need to focus on voice input.

Speech conversion system 21 consists of the following systems:
Voice Input System 61
Language Conversion System 62
Speech Command Production System 63

Voice Input System

Voice input system 61 is similar to the system described in the patent application Ser. No. 15/587,234. However, there is some specificity due to the nature of interaction with IoT. The goal is to convert user's voice into a codebook that matches pre-recorded phrases reflecting commands understood by IoT devices. Because the list of commands is limited, user can communicate to speech conversion system using any words or phrases as soon as there is clear mutual understanding which user's phrase matches which command. This leeway allows to use long phrases and very distinct words that are less confusing to ASR to compensate for speech impediments and heavy regional accents for native speakers and insufficient quality of recognition of ASR for the mother tongue of a non-native speaker.

Voice input system uses pronunciation peculiarities & errors repository 18 to avoid words and phrases that include such peculiarities and/or errors (instead of trying to improve user's pronunciation) and uses deliberately alternative phrase generation system 17 to have words/phrases that are distant to other phrases in the phonetic space to procure reliable recognition even for not so good ASR.

Language Conversion System

The language conversion system 62 (LCS) deals with the cases of non-native speakers that do not have enough proficiency in the language that ASR can recognize with high level of quality.

LCS takes the list of voice commands that a particular box (e.g. Amazon Echo) recognizes as commands to a particular IoT device (e.g. a thermostat). Then it translates these commands to a native tongue of a non-native speaker. Then it applies words/phrases from phrase similarity repository 16 to build a level 1 neighborhood of the phrases to be pronounced. Then it applies alternative phrase generation system 17 to build a level 2 neighborhood. Then LCS chooses the phrases from both neighborhoods that are the most isolated in phonetic space according to, for example, Levenshtein distance between IPA canonical phonetic representation. These phrases then become the phrases that are communicated to the user as the ones that need to be pronounced to initiate the corresponding commands.

With the continuous use, LCS can also build and then use pronunciation peculiarities & errors repository 18 in user's mother tongue to modify chosen phrases to achieve higher recognition from ASR in user's mother tongue.

Speech Command Production System

The most straightforward way to mitigate severe impediments in user speech is to use text-to-speech (TTS) capabilities (instead of user's voice) while talking to a box like Amazon Echo. The problem though is that, even for humans, TTS output is often difficult to comprehend. ASR in most cases cannot recognize this “mechanical” voice since it was not normally trained to do it. It is possible to train the ASR for TTS but there is no sufficient market pressure to do that. Therefore, speech command production system 63 instead uses pre-recorded utterances of native speakers. This would not be feasible for application such as dictation with large vocabularies and potentially infinite number of phrases. However, for IoT command and control world this approach works since the number of commands/phrases is quite limited. In fact, each voice-based control box has its own list of phrases that it can interpret as a command to a particular IoT device (e.g. a light bulb). These phrases are typically a part of published nomenclature and can be pre-recorded by native speakers or can be extracted from already existing spoken corpora. Therefore, speech command production system 63 can be used as a “converter” with phrase (or phrase position in the list of allowed phrases) as input and pre-recorded phrase being played back as output.

Human-Machine Interface System

Human-machine interface consists of two parts—end user interface and designer interface systems.

User interface system provides user with feedback on errors that user made while talking to a machine. The goal is to help user to improve voice-based communication with a machine. The feedback can be provided on the screen of device (e.g. smartphone, car navigation device) or can use text-to-speech capability to speak to a user after certain thresholds of error repetition are reached.

This system can be used in an offline mode during training sessions or online during user interaction with the machine. In the latter case, the system uses the results of the analysis of the latest user utterance and communicates back to user suggestions on improvement of pronunciation and/or changing the pronounced words to their synonyms with higher chance of being better pronounced and/or better recognized. It can also provide feedback on other aspects of the utterance such as speech disfluencies and incorrect grammar.

Designer interface system provides a designer of voice-based dialog system with feedback on what kind of changes the designer can make to improve quality of recognition and thus usability of the system being designed. The feedback is based on the idea that a designer enters nomenclature of a dialog and the machine provides alternatives that have similar meaning but are more “remote” from other words/phrases and thus more likely not to be confusing to ASR.

The system can provide different alternatives depending on the nomenclature of the dialog, type of speaker (native, non-native), and individual peculiarities/errors of a particular user. The latter is especially useful for dynamic feedback to user during the dialog that can be a part of the overall system design.

Sample System Configurations

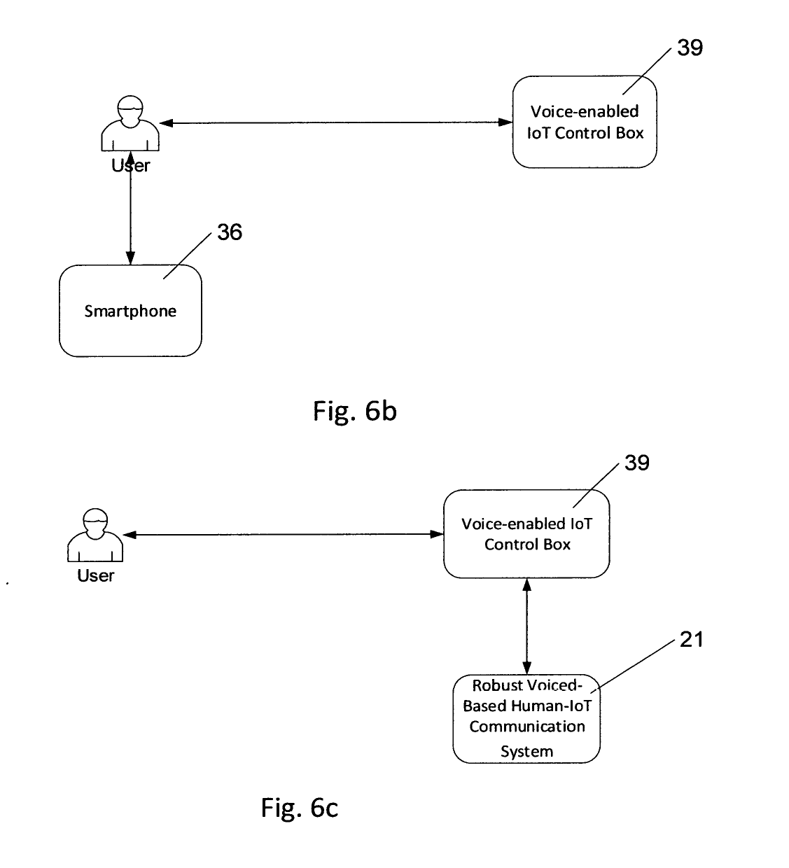

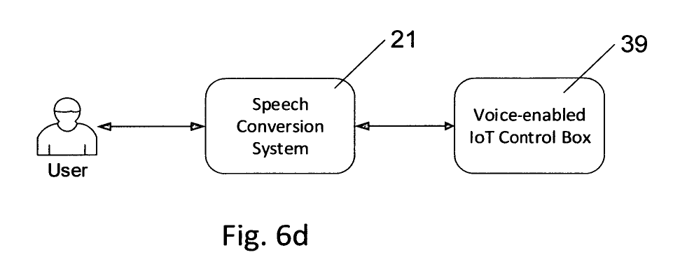

The described invention can be used in a number of ways. Below are shown four possible configurations of such a use. These four configurations are shown in FIGS. 6a-6d.

Human—Third Party Voice-enabled Box with ASR API—IoT

FIG. 6a shows a configuration that could be used when working with boxes that for example have Android OS to control IoT. Since the box has a build-in API that can be used to obtain N-Best results of user utterance recognition then a smartphone or a separate box can be used to communicate to user the way to improve the quality of results by either improving pronunciation of certain phonemes or sequences of phonemes or changing the phrases to the ones that are still within the purveyance of the box but would be better recognized. In the line of human-machine communication this configuration is skewed towards human moving to machine while machine stays where it is. In this case, the smartphone application that is based on this invention is used as a not in-line (parallel) device in communication and serves as an advisor.

Human—Third Party Voice-enabled Box without ASR API—IoT

FIG. 6b shows a configuration that could be used when working with close boxes to control home appliances or iPhone controlling a car. Since the box is non-transparent for developers, a separate device (e.g. Android-based smartphone) can be used to analyze user utterances and to communicate to user the way to improve the quality of results by either improving pronunciation of certain phonemes or sequences of phonemes or changing the phrases to the ones that are still within the purveyance of the box but would be better recognized. In the line of human-machine communication, this configuration is skewed towards human moving to machine while machine stays where it is. In this case, the smartphone application that is based on this invention is used as a not in-line (parallel) device in communication and serves as an advisor.

The smartphone application will potentially use a different ASR. So, potentially errors of Echo will not be exactly the same as errors for Google ASR. However, error types of different ASRs should overlap quite significantly due to a similar nature of mechanisms used to build them.

Human—Proprietary Voice-enabled Box—IoT

FIG. 6c shows a configuration the the box is proprietary and thus can incorporate all mechanisms that are presented in this invention including multi-language operation. This will eliminate the need of any additional devices. Such configuration has already become popular due to extensive work of several companies in building IoT communication platforms with SDK that enable wide development community.

Human—Intermediary Device—Third Party Voice-enabled Box—IoT

FIG. 6d shows a configuration that addresses specifically cases of speakers who do not speak languages that the Voice-enabled Box can recognize with high quality, speakers with heavy regional accents and speakers with speech impediments. The intermediary device is used as a “converter” from what user said to spoken phrases by native speakers that will be recognized by the third party voice-enabled box.

While preferred illustrative embodiments of the invention are described above, it will be apparent to one skilled in the art that various changes and modifications may be made therein without departing from the invention. The appended claims are intended to cover all such changes and modifications that fall within the true spirit and scope of the invention.

What is claimed is:

1. A system for creating robust voice-based human IoT communications comprising of:
a speech recognition system that analyzes an utterance spoken by the user and returns a ranked list of recognized phrases;
a speech analysis module that analyzes a list of recognized phrases and determines the issues that led to less than desirable recognition results;
an alternative phrase generation system that takes phrases that are relevant to a particular application and finds phrases that are similar to them in meaning that lead to better recognition results;
a user feedback module that converts results of speech module into instructions to the user on how to improve the results of speech recognition by changing pronunciation, speech flow and grammar of user's speech habits and which alternative phrases with similar meaning to use;
a design feedback module that takes into account pronunciation peculiarities and errors of target users and used ASR and provides system designer with recommendations on how to change existing words and phrases nomenclature to a nomenclature that conveys same or similar meaning but would be more reliably recognized by ASR;
a speech conversion module that takes voice input from a user and produces voice output into a voice-enabled IoT device or a voice-enabled IoT control box that controls IoT devices;
a human-machine interface that communicates to designer the recommendations of the design feedback module; and
a human-machine interface that communicates visually or aurally the recommendations of the user feedback module.

2. The system of claim 1 where users' utterances are stored in an utterance repository accessible via internet.

3. The system of claim 1, further comprising a performance repository accessible via the Internet, wherein users' mispronunciations and speech peculiarities are stored corresponding to their types.

4. The system of claim 1, further comprising a speech analysis system that stores users' mispronunciations and speech peculiarities in a performance repository accessible via the Internet.

5. The system of claim 1, further comprising a phrase similarity repository that contains words and phrases that convey same or similar meaning as the words and phrases in the existing human-IoT dialog, but will be more reliably recognized by ASR.

6. The system of claim 1, further comprising of an alternative phrase generation system that builds alternative words and phrases that convey same or similar meaning as the words and phrases in the existing human-IoT dialog but will be more reliably recognized by ASR and stores them in a phrase similarity repository accessible via the Internet.

7. The system of claim 1, further comprising a pronunciation peculiarities and errors repository accessible via the Internet, wherein information about typical mispronunciation and errors of people speaking with different foreign accents is stored according to their types.

8. The system of claim 1, wherein a speech recognition system is accessible via the Internet.

9. The system of claim 8, wherein a speech recognition system comprises a publicly available third-party speech recognition system.

10. The system of claim 1, further comprising a user feedback system that applies data analytics to the data stored in a performance repository to dynamically generate instructions to the user on how to improve the results of speech recognition by changing pronunciation, speech flow and grammar of user's speech habits and which alternative phrases with similar meaning the user should use.

11. The system of claim 1, further comprising of a design feedback module that takes into account pronunciation peculiarities and errors of target users and used ASR and provides system designer with recommendations on how to change existing words and phrases nomenclature to a nomenclature that conveys the same or similar meaning but would be more reliably recognized by ASR;

12. The system of claim 1, further comprising of a speech conversion system that takes input from a user and produces voice output into a voice-enabled IoT control box that will be better understood by ASR.

13. The system of claim 1 wherein a human-machine interface is configured to operate on a mobile device.

14. A method for creating robust voice-based human IoT communications comprising of:
analyzing user utterances using a speech recognition system, the speech recognition system returning a ranked list of recognized phrases;
using the ranked lists of recognition results to build user's pronunciation profile consisting of user's mispronunciations and speech peculiarities organized by types;
using internet, thesauri and other sources to build alternative words and phrases that convey same or similar meaning to the words and phrases in the existing human-IoT dialog but that are more reliably recognized by ASR;
providing guidance to voice-based dialog designer;
building guidance to the user on how to improve the results of speech recognition by changing the words and phrases user uses in communication with the machine to words and phrases that convey the same or similar meaning but that would be more reliably recognized by ASR; and
providing guidance to the user visually or aurally; and
taking input from a user and producing voice output into a voice-enabled IoT device or a voice-enabled IoT control box that controls IoT devices that would be more reliably recognized by ASR than the user's original speech.

15. The method of claim 14, further comprising accessing a speech recognition system via the Internet.

16. The method of claim 15, wherein accessing a speech recognition system via the Internet comprises accessing a publicly available third-party speech recognition system.

17. The method of claim 14, wherein the communication with the user is performed using a mobile device.

18. The method of claim 14, wherein instead of user talking to an IoT, control box a speech conversion system takes user's voice and produce voice output to the IoT control box.
